(19) United States
(12) Patent Application Publication
(10) Pub. No.: US 2011/0141159 A1
(43) Pub. Date: Jun. 16, 2011

(54) IMAGE DISPLAY APPARATUS, ITS DRIVING METHOD AND APPARATUS DRIVING PROGRAM

(75) Inventor: Yasuhiro Takeuchi, Nagano (JP)

(73) Assignee: C/O SONY CORPORATION, Tokyo (JP)

(21) Appl. No.: 12/965,268

(22) Filed: Dec. 10, 2010

(30) Foreign Application Priority Data
Dec. 16, 2009 (JP) P2009-284865

(51) Int. Cl. G09G 5/10

(52) U.S. Cl. 345/690

(57) ABSTRACT

An image display apparatus includes: a display panel in which every pixel is configured to have at least four sub-pixels provided for respectively at least four color components different from each other and each of the sub-pixels is driven to exhibit a luminance according to the color component for the sub-pixel; a processing circuit configured to receive input information provided for the display panel to serve as information on a color prescribed by a table color system determined in advance and configured to output the four or more color components based on the information; and a color measurement unit configured to measure the color of light coming from an environment surrounding the display panel.

### CROSS REFERENCES TO RELATED APPLICATIONS

The present application claims priority to Japanese Priority Patent Application JP 2009-284865 filed in the Japan Patent Office on Dec. 16, 2009, the entire content of which is hereby incorporated by reference.

### BACKGROUND

The present application relates to technological fields of an image display apparatus, an apparatus driving method for driving the image display apparatus and an apparatus driving program implementing the apparatus driving method.

In general, a color image is expressed by an additive color mixture of three primary colors, i.e., the R (red), G (green) and B (blue) colors. However, the expressible color gamut is limited to a three-dimensional space, each point in which is indicated by three vectors representing the three primary colors respectively. In order to enlarge the expressible color gamut in an attempt made to solve this problem, in recent years, a display panel making use of four or more primary colors is coming on stage. However, the display panel making use of four or more primary colors raises a problem as to how a desired color can be reconstructed with a high degree of accuracy. In order to solve this problem, there has been proposed, among other technologies, a technology for transforming three stimulus values prescribing a desired color into four primary colors each serving as a color component of the desired color, which is to be displayed on a display panel, by referring to a lookup table. For more information on this proposed technology, the reader is advised to refer to Japanese Patent Laid-Open No. 2000-338950.

### SUMMARY

With the technology cited above, however, the four primary colors each serving as a color component cannot always be found with a high degree of accuracy in one computation from three stimulus values. In addition, even if the four primary colors found from the three stimulus values as primary colors each serving as a color component are optimized for a certain specific display panel, the four primary colors may not be components which have been optimized for another display panel in some cases due to differences in characteristics and/or differences in manufacturing lot between individual di splay panels.

On top of that, the technology cited above does not give consideration to changes of light coming from an environment surrounding the display panel. That is to say, as is commonly known, in general, even when a physical body is objectively perceived, the same body may be perceived and/or recognized at colors different from the true colors of the body in some cases due to changes in attributes such as the color and property of light coming from the environment which surrounds the display panel. When a white cloth is perceived at any time of the day and at night for example, the cloth coloring for the time of the day of full daylight coming from the sun seemingly tends to be typically different from the cloth coloring for incandescent light at the nighttime. Such a difference needs to be taken into consideration. With such a difference taken into consideration, if the display panel continues to show the same color as the existing one in spite of the fact that the light from the surrounding environment changes, the color continued to be shown by the display panel to the user may differ from a color which is visible in actuality.

Addressing the problems described above, inventors of an embodiment have proposed an image display apparatus capable of solving some of the problems, a method for driving the display apparatus and an apparatus driving program implementing the method.

An image display apparatus provided by the present embodiments to solve the problems described above is an image display apparatus employing a display panel in which every pixel is configured to have at least four sub-pixels provided for respectively at least four color components different from each other and each of the sub-pixels is driven to exhibit a luminance according to the color component for the sub-pixel. In addition, the image display apparatus also includes a processing circuit for receiving input information provided for the display panel to serve as information on a color prescribed by a table color system determined in advance and for outputting the four or more color components based on the information. On top of that, the image display apparatus also includes a color measurement unit for measuring the color of light coming from an environment surrounding the display panel. If the color measured by the color measurement unit as the color of light coming from an environment at a first point of time is different from the color measured by the color measurement unit as the color of light coming from the environment at a second point of time following the first point of time, the processing circuit outputs at least four such adjusted color components that a color prescribed by the information is adjusted to the color of the light coming from the environment at the second point of time.

In accordance with the present embodiments, if the color measured by the color measurement section as the color of light coming from an environment surrounding the display panel at a first point of time is different from the color measured by the color measurement section as the color of light coming from the environment at a second point of time different from the first point of time, a color shown on the display panel changes in accordance with the difference. In addition, in this case, the different color shown on the display panel after the measured color has changed is determined on the basis of the four or more adjusted color components which are adjusted to the difference between the color of light coming from the environment at the first point of time and the color measured by the color measurement section as the color of light coming from the environment at a second point of time different from the first point of time. As described above, in accordance with the present embodiments, in conformity with the change of the color of light coming from the environment surrounding the display panel, a color which should be actually visible to the user can be shown on the display panel with a high degree of accuracy.

It may be more accurate to say that the technical term ‘color adjustment’ used in the description of the present embodiments implies the following fact. For example, let reference notation C1 denote a color shown on the display panel at a first point of time whereas reference notation EC1 denote a color of light coming from an environment surrounding the display panel at the first point of time. When the color of light coming from the environment surrounding the display panel changes from EC1 to EC2 at a second point of time, that is, when a surrounding-environment color transition of EC1→EC2 is made, the color C1 appearing on the display panel is shown under the color EC2 of light coming from the environment surrounding the display panel. If the color C1 appearing on the display panel is indeed to be shown within the color EC2 of light coming from the environment surrounding the display panel, the color C1 appearing on the display panel must be changed to a color C2 in a ‘color adjustment’ process. The color C2 is a supposed color which should probably be naturally visible to the user. In general, the color C2 is different from the color C1. It is to be noted that, the color adjustment process is not a process to change the color shown on the display panel so that, also under the environment color EC2, the same color C1 as that shown under the color EC1 of light coming from the environment is displayed.

In addition, the technical term ‘color measurement section’ used in the description of the present embodiments typically means a section included in the image display apparatus to serve as a portion of the image display apparatus. In the case of the present embodiments, however, the technical term ‘color measurement section’ is not necessarily limited to imply a section embedded in the image display apparatus. That is to say, the color measurement section for measuring the color of light coming from an environment surrounding the display panel can also be provided as another section which is physically separated from the image display apparatus.

It is also possible to construct the image display apparatus according to the present embodiments into a configuration in which the processing circuit outputs the four or more adjusted color components by changing the four or more adjusted color components from time to time so that a color shown on the display panel at the first point of time changes gradationally to a color which is based on the four or more adjusted color components.

In accordance with this configuration, the rate of the change of the displayed color shown on the display panel is relatively low. Thus, in accordance with this configuration, it is possible to preventively get rid of a problem that the user feels flickering due to abrupt changes of the displayed color.

It is also possible to construct the image display apparatus according to the present embodiments into a configuration in which the color of light coming from the environment surrounding the display panel at the second point of time is not a color measured by the color measurement section, but a color determined in accordance with a command which is issued by the user.

In accordance with this configuration, even though the color of light coming from the environment surrounding the display panel does not actually change, if the color of light coming from the environment surrounding the display panel should change at all, it will be possible to check at what color the displayed color presently shown on the display panel would probably be visible to the user. It is to be noted that, in the case of this configuration, the user issues a command for specifying the color which is assumed to be the color of light coming from the environment surrounding the display panel. To put it more concretely, the user issues a command for specifying the color which is assumed to be the color of light coming from the environment surrounding the display panel at the aforementioned second point of time in this configuration.

The image display apparatus described above can be interpreted as an embodiment in addition to an embodiment of a driving method for well driving the image display apparatus and an embodiment of an image display program to be executed by a computer as a program implementing the driving method for driving the image display apparatus. The driving method for driving the image display apparatus and the image display program to be executed by a computer as a program implementing the driving method for driving the image display apparatus are prescribed as follows.

A driving method is provided by the present embodiments to serve as a method for driving an image display apparatus in order to solve the problems described above. The image display apparatus employs a display panel in which every pixel is configured to have at least four sub-pixels provided for respectively at least four color components different from each other and each of the sub-pixels is driven to exhibit a luminance according to the color component for the sub-pixel. The driving method provided by the present embodiments to serve as a method for driving the image display apparatus includes a color-component outputting process of receiving input information provided for the display panel to serve as information on a color prescribed by a table color system determined in advance and outputting the four or more color components based on the information as well as a color measurement process of measuring the color of light coming from an environment surrounding the display panel. If the color measured at the color measurement process as the color of light coming from the environment at a first point of time is different from the color measured at the color measurement process as the color of light coming from the environment at a second point of time following the first point of time, the color-component outputting process is carried out to output at least four such adjusted color components that a color prescribed by the information is adjusted to the color of light coming from the environment at the second point of time.

In order to solve the problems described above, an image display program is provided by the present embodiments to serve as a program to be executed by a computer for driving an image display apparatus employing a display panel in which every pixel is configured to have at least four sub-pixels provided for respectively at least four color components different from each other and each of the sub-pixels is driven to exhibit a luminance according to the color component for the sub-pixel. The computer executes the image display program in order to function as a processing section configured to receive input information provided for the display panel to serve as information on a color prescribed by a table color system determined in advance and to output the four or more color components based on the information as well as to serve a color measurement section configured to measure the color of light coming from an environment surrounding the display panel. In addition, the processing section also serves as a color-component outputting section configured to further output at least four such adjusted color components that a color prescribed by the information is adjusted to the color of light coming from the environment at a second point of time following a first point of time if the color measured by the color measurement section as the color of light coming from the environment at the first point of time is different from the color measured by the color measurement section as the color of light coming from the environment at the second point of time.

Additional features and advantages are described herein, and will be apparent from the following Detailed Description and the figures.

### BRIEF DESCRIPTION OF THE FIGURES

FIG. 1 is a plurality of perspective-view diagrams each showing the configuration of an image display apparatus according to an embodiment;

FIG. 2 is a block diagram showing the configuration of the image display apparatus;

FIG. 3 is a block diagram showing the functional configuration of the image display apparatus;

FIG. 4 is a block diagram showing the functional configuration of the image display apparatus set in a normal display mode;

FIG. 5 is a block diagram showing the functional configuration of the image display apparatus set in a single-color display mode;

FIG. 6 is a block diagram showing the functional configuration of the image display apparatus set in a calibration mode;

FIG. 7 shows a flowchart representing operations carried out in the calibration mode;

FIG. 8 is a diagram showing a color reproduction zone RCD expressed on an xy chromaticity diagram to serve as a color reproduction zone RCD of the display panel;

FIG. 9 is a diagram showing typical fractional sub-zones on the xy chromaticity diagram;

FIG. 10 is a plurality of diagrams showing respectively a color reproduction solid RCD expressed in the space of an XYZ chromaticity system to serve as a color reproduction solid RCD of the display panel 100 and a set of vectors;

FIGS. 11A to 11H are a plurality of diagrams showing typical fractional sub-solids in the space of the XYZ chromaticity system;

FIG. 12 is a block diagram showing a functional configuration of the image display apparatus set in a surrounding-environment-light-based adjustment mode;

FIG. 13 shows a flowchart representing operations carried out in the surrounding-environment-light-based adjustment mode; and

FIG. 14 is a block diagram showing a functional configuration of the image display apparatus set in a surrounding-environment-light-based adjustment mode different from the surrounding-environment-light-based adjustment mode in which the image display apparatus shown in the block diagram of FIG. 12 is set.

### DETAILED DESCRIPTION

Embodiments of the present application will be described below in detail with reference to the drawings.

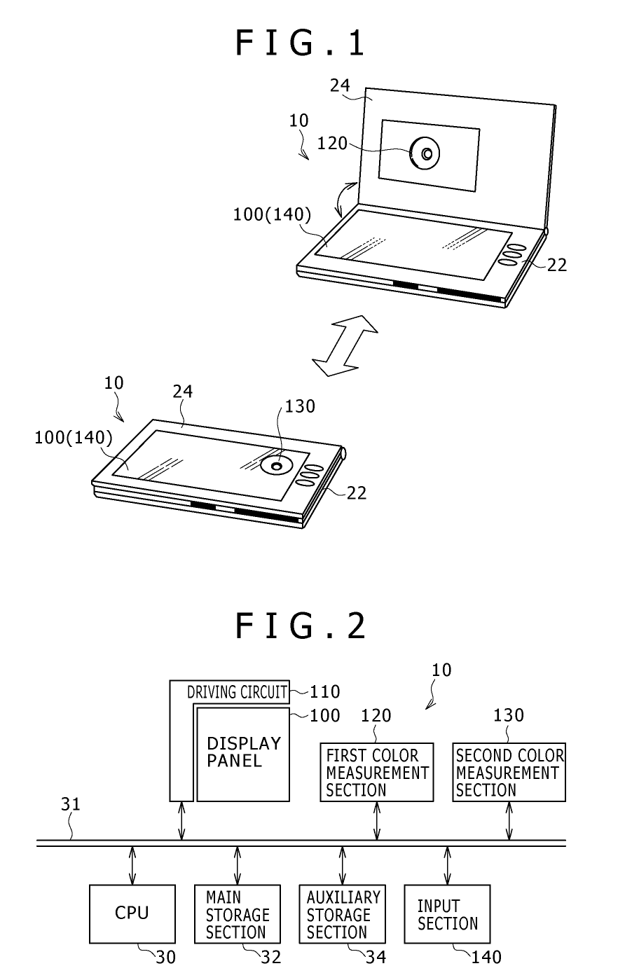

FIG. 1 is a plurality of perspective-view diagrams each showing the configuration of an image display apparatus 10 according to an embodiment. The image display apparatus 10 has not only functions of a portable terminal, but also a color chart function for displaying a variety of colors with a high degree of accuracy.

As shown in the perspective-view diagrams of FIG. 1, the image display apparatus 10 employs a display panel 100 provided on a main body 22. The display panel 100 is a transmission-type liquid-crystal display panel which has a plurality of pixels. In order to enlarge the zone of reproducible colors, each of the pixels on the display panel 100 is configured to have four sub-pixels for respectively four colors, i.e., the R (red), YG (yellow green), EG (emerald green) and B (blue) colors. The transmittance of each of the sub-pixels is controlled individually in accordance with the color component of the sub-pixel. In addition, the display panel 100 is provided with an input section 140 which is to be operated by the user to enter a variety of inputs. The user operates the input section 140 by touching the input section 140.

The image display apparatus 10 has a cover board 24. As shown in the perspective-view diagrams of FIG. 1, the cover board 24 is attached to the main body 22 in such a way that the cover board 24 can be rotated with a high degree of freedom around the main body 22.

The cover board 24 is provided with a first color measurement section 120 and a second color measurement section 130. When the cover board 24 is put in a state of being closed to cover the main body 22, the first color measurement section 120 measures the color of an image which is being displayed on the display panel 100. On the other hand, when the cover board 24 is put in the same state of being closed to cover the main body 22, the second color measurement section 130 measures the color of light coming from an environment surrounding the image display apparatus 10. In the following description, the light coming from an environment surrounding the image display apparatus 10 is also referred to simply as surrounding-environment light in some cases.

As described above, each of the first color measurement section 120 and the second color measurement section 130 is capable of best exhibiting its performance when the cover board 24 is put in the state of being closed to cover the main body 22. It is to be noted, however, that each of the first color measurement section 120 and the second color measurement section 130 is capable of best exhibiting its performance not necessarily only when the cover board 24 is put in the state of being completely closed to cover the main body 22 as shown in the lower left perspective-view diagram of FIG. 1. In other words, even when the cover board 24 is put in a state of being merely semi-closed to cover the main body 22, the first color measurement section 120 is also capable of measuring the color of an image which is being displayed on the display panel 100 whereas the second color measurement section 130 is also capable of measuring the color of light coming from an environment surrounding the image display apparatus 10.

FIG. 2 is a block diagram showing the configuration of the image display apparatus 10.

As shown in the block diagram of FIG. 2, the image display apparatus 10 is configured to employ a CPU (Central Processing Unit) 30 for controlling a variety of other sections employed in the image display apparatus 10 and exchanging various kinds of data with the sections through a bus 31. The sections employed in the image display apparatus 10 include a main storage section 32, an auxiliary storage section 34, an input section 140, a driving circuit 110, the aforementioned first color measurement section 120 and the second color measurement section 130 cited above.

The main storage section 32, which is one of the sections employed in the image display apparatus 10, is a volatile memory such as a DRAM (Dynamic Random Access Memory). The main storage section 32 is used for temporarily storing a program being executed by the CPU 30 and information such as data used in the execution of the program. The auxiliary storage section 34 is a nonvolatile storage device such as an HDD (Hard Disk Drive) or an SSD (Solid State Drive). The auxiliary storage section 34 is used for storing an operating system, application programs and various kinds of data. It is to be noted that a program mentioned in the description of the present embodiments has been stored in the auxiliary storage section 34 or the main storage section 32 to be executed by the CPU 30 sequentially one program after another.

The driving circuit 110 is a circuit for receiving an input color components for four colors per pixel and for driving every pixel (or, strictly speaking, every sub-pixel) of the display panel 100 so that each sub-pixel exhibits a transmittance according to a color component for the sub-pixel.

FIG. 3 is a block diagram showing a functional configuration constructed for the image display apparatus 10 to serve as a functional configuration which is needed by the image display apparatus 10 when the display panel 100 is displaying an image (or colors).

In the image display apparatus 10, a processing circuit 40 receives input information such as image signals of three color components and color IDs (identifiers), driving sub-pixels on the display panel 100. On the other hand, the first color measurement section 120 measures a color appearing on the display panel 100 whereas the second color measurement section 130 measures the color of light coming from the environment surrounding the image display apparatus 10.

It is to be noted that the processing circuit 40 is a functional block which is created when the CPU 30 is executing a program. An image signal supplied to the processing circuit 40 is generated by a functional block which is located on the upstream side of the processing circuit 40.

All the functional blocks shown in the block diagram of FIG. 3 are not constructed in the processing circuit 40 at the same time. Instead, the functional blocks are properly constructed in accordance with a mode set at that time. The processing circuit 40 according to the embodiment can be set in one of four modes, i.e., a normal display mode, a single-color display mode, a calibration mode and a surrounding-environment-light-based adjustment mode. Any one of the four modes can be specified by an operation carried out on the input section 140. The normal display mode, the single-color display mode, the calibration mode and the surrounding-environment-light-based adjustment mode are explained as follows.

Normal Display Mode

In the normal display mode, operations are carried out to input an image signal prescribed by three color components, i.e., the R, G and B color components, and output an image based on the image color to the display panel 100 as is the case with the image display apparatus 10 which functions as a portable terminal.

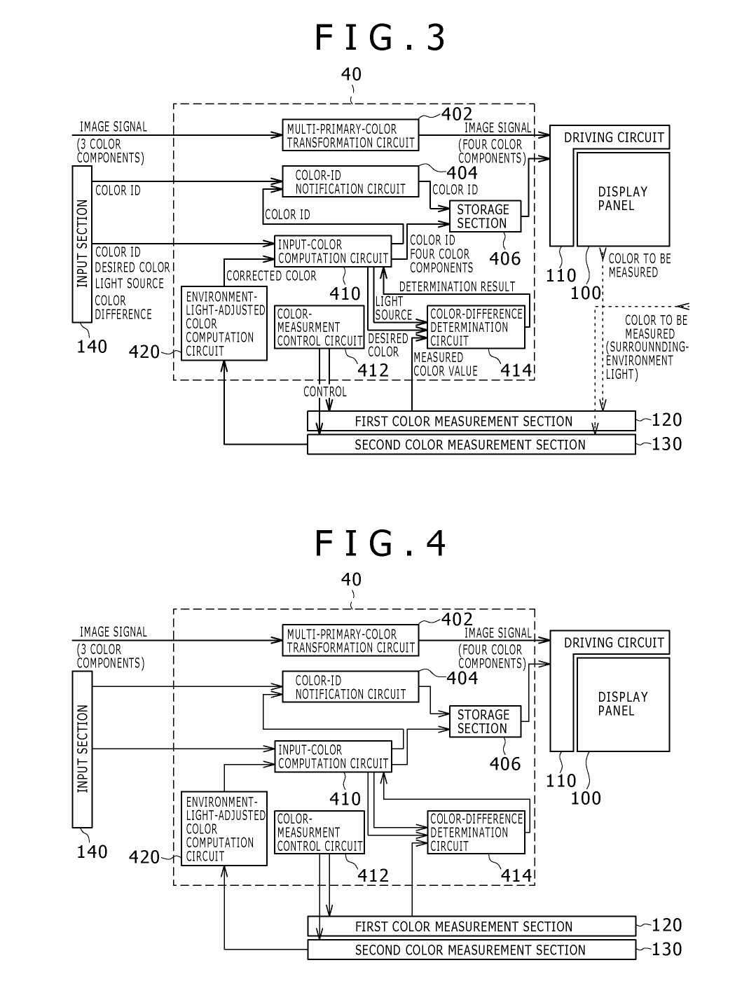

FIG. 4 is a block diagram showing a functional configuration which is constructed by the processing circuit 40 as the functional configuration of the image display apparatus 10 set in the normal display mode. In the functional configuration shown in the block diagram of FIG. 4, a multi-primary-color transformation circuit 402 transforms an image signal of the three color components, i.e., the R, G and B color components, into an image signal of four color components, i.e., R, YG, B and EG color components, supplying the image signal of the four color components to the driving circuit 110.

The driving circuit 110 drives sub-pixels on the display panel 100 in accordance with the image signal obtained from the conversion carried out by the multi-primary-color transformation circuit 402 as the image signal of the four color components. Thus, the display panel 100 shows an image based on the image signal supplied to the processing circuit 40.

Simple-Color Display Mode

In the simple-color display mode, a color chart function is carried out to show an accurate color to the user. In this simple-color display mode, the display panel 100 shows only a color serving as a color chart.

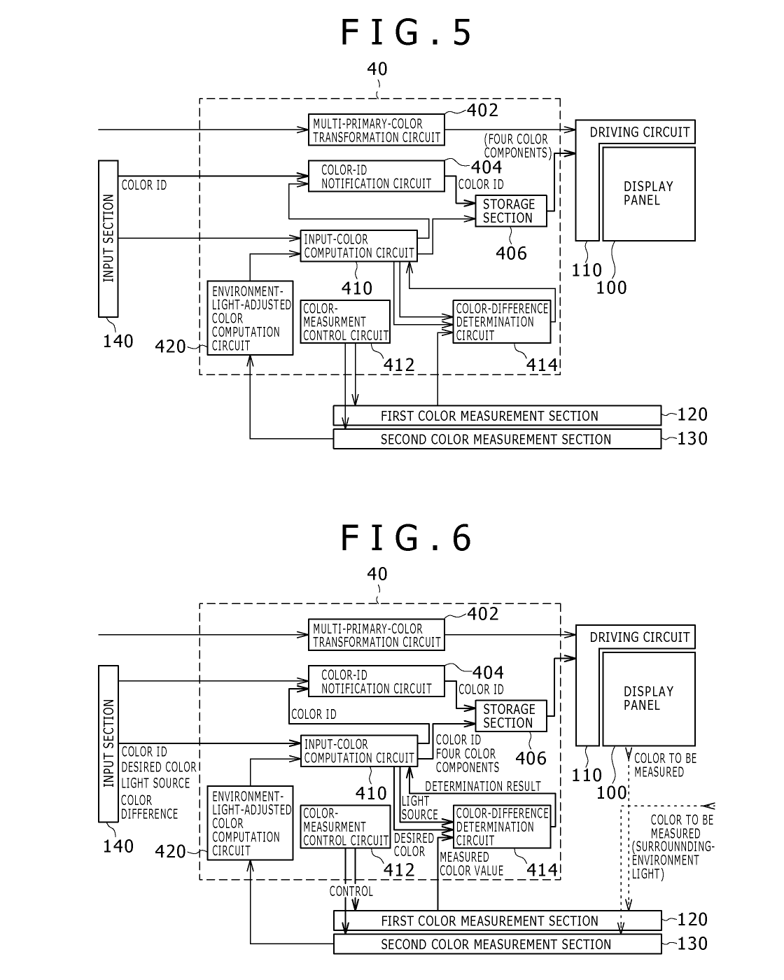

FIG. 5 is a block diagram showing a functional configuration which is constructed by the processing circuit 40 as the functional configuration of the image display apparatus 10 set in the single-color display mode. In the functional configuration shown in the block diagram of FIG. 5, a color ID (identifier) used for identifying a color to be displayed on the display panel 100 is supplied to the input section 140 in an operation carried out by the user on the input section 140. A storage section 406 is allocated to a database stored in the auxiliary storage section 34 explained earlier. The database is used for storing color IDs, colors shown by a variety of table color systems and the four color components, i.e., the R, YG, B and EG color components used in reproduction of a color on the display panel 100 in advance by associating the storing color IDs, the colors shown by a variety of table color systems and the four color components with each other.

An ID notification circuit 404 notifies the storage section 406 of a color ID entered to the processing circuit 40 through the input section 140. The storage section 406 outputs the four color components for the color ID to the driving circuit 110.

Since the driving circuit 110 drives sub-pixels on the display panel 100 in accordance with an image signal of the four color components received from the storage section 406, the display panel 100 shows a color for the color ID entered to the processing circuit 40 through the input section 140.

Calibration Mode

In the following description, the technical term ‘desired color’ is used to imply a color which is desired by the user as a displayed color or to imply a color which is to be displayed. There is a case in which, even though a command has been issued to express a desired color, another color different from the desired color is shown on the display panel 100. In such a case, the display of the other color is corrected so that a color close to the desired color to a maximum extent is shown on the display panel 100. Ideally, the other color matches the desired color. The calibration mode is a mode in which the other color is corrected so that a color closest to the desired color is shown on the display panel 100. Such a difference between the desired color and the other color which is an actually expressed color is attributed to a variety of causes such as a variation between individual panel displays 100, an aging change of the display panel 100 and a computation error.

Details of the calibration mode are explained specially in the following chapter.

Details of the Calibration Mode

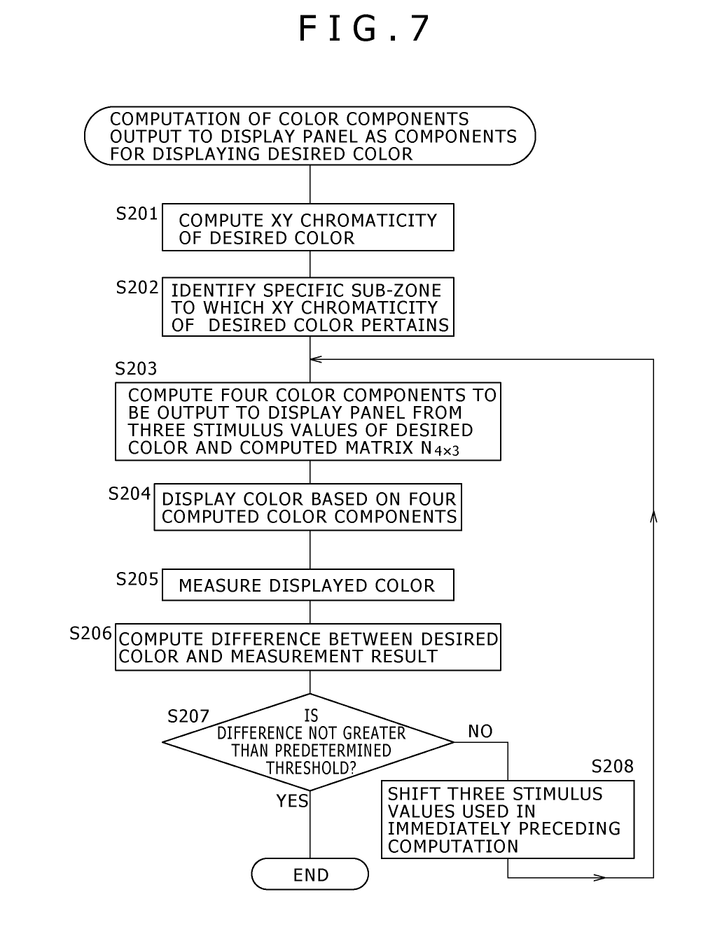

FIG. 6 is a block diagram showing a functional configuration which is constructed by the processing circuit 40 as the functional configuration of the image display apparatus 10 set in the calibration mode whereas FIG. 7 shows a flowchart representing operations carried out in the calibration mode. First of all, by referring to the block diagram of FIG. 6 and the flowchart of FIG. 7, the following description explains an outline of execution of the calibration mode.

When the user gives information prescribing a desired color, an input-color computaion circuit 410 computes the xy chromaticity of the desired color at a step S201 of the flowchart shown in FIG. 7. The information prescribing the desired color is information defined in an absolute color space which is not dependent on the device. A typical example of the information prescribing a desired color is information defined in a XYZ table color system, the CIE 1976 (or the L*a*b table color system) or another table color system such as a spectroscopic energy distribution system or an xy chromaticity system. In the case of the information defined in a XYZ table color system, the information prescribing a desired color is given as three stimulus values (that is, three stimulus values X, Y, Z).

It is to be noted that, when the user enters the information prescribing a desired color by operating the input section 140, the user may enter information including a color ID used for identifying the desired color and an allowable color difference to be described later.

After the xy chromaticity of the desired color is received, the input-color computaion circuit 410 finds the four color components, i.e., the R, YG, B and EG color components, which are used for displaying the desired color, on the basis of the xy chromaticity. The input-color computaion circuit 410 finds the four color components by adoption of a transformation algorithm like one which will be described later in detail in a chapter given later as a chapter with a title of “Algorithm of Transforming three stimulus values into four color components.” Even though the transformation algorithm will be described later in detail in this chapter, a rough flow of the algorithm will be described in brief as follows.

First of all, at a step S202 of the flowchart shown in FIG. 7, the input-color computaion circuit 410 identifies a specific sub-zone, to which the xy chromaticity of the desired color pertains, among sub-zones 1 to 8 shown in a diagram of FIG. 9. After the input-color computaion circuit 410 identifies the specific sub-zone, the flow of the calibration-mode execution represented by the flowchart shown in FIG. 7 goes on to a step S203 at which the input-color computaion circuit 410 computes the four color components (that is, the R, YG, B and EG color components) to be output to the display panel 100 on the basis of the three stimulus values X, Y and Z of the desired color as well as a matrix N4×3 of the sub-zone to which the xy chromaticity of the desired color pertains. It is to be noted that the matrix N4×3 is a transformation matrix used for transforming a set of three vectors into a set of four vectors. The transformation of a set of three vectors into a set of four vectors will also be explained in detail in the chapter given later as the chapter with a title of “Algorithm for Transforming Three Stimulus Values into Four Color Components.”

Then, the input-color computaion circuit 410 stores the four color components computed at the step S203 of the flowchart shown in FIG. 7 in the storage section 406, associating these color components with the input color ID.

The input-color computaion circuit 410 also supplies the input color ID to the ID notification circuit 404. Receiving the input color ID from the input-color computaion circuit 410, the ID notification circuit 404 reads out the four color components associated with the color ID from the storage section 406 and supplies the four color components to the driving circuit 110. The four color components read out by the ID notification circuit 404 from the storage section 406 are the four color components computed by the input-color computaion circuit 410 at the step S203 of the flowchart shown in FIG. 7. Then, at a step S204 of the flowchart shown in FIG. 7, the display panel 100 expresses a color based on these four color components.

It is quite within the bounds of possibility, however, that the actually expressed color is different from the desired color due to a variety of causes including an aging degradation of the display panel 100.

Then, at a step S205 of the flowchart shown in FIG. 7, a color-measurement control circuit 412 issues a command to the first color measurement section 120, requesting the first color measurement section 120 to measure a color expressed on the display panel 100 as the color of an image being shown by the display panel 100. In accordance with this command, the first color measurement section 120 outputs three stimulus values of the measured color, that is, three stimulus values for a result of the measurement of the color. In addition, it is recommended to have the first color measurement section 120 measure the color of an image which is being displayed on the display panel 100 when the cover board 24 is put in a state of being closed to cover the main body 22. Thus, it is recommended to provide a configuration in which, if the cover board 24 has not been put in a state of being closed to cover the main body 22, the image display apparatus 10 issues a message requesting the user to put the cover board 24 in a state of being closed to cover the main body 22. The image display apparatus 10 issues such a message by making use of some means. To put it more concretely, the image display apparatus 10 issues such a message by typically generating a sound or putting a warning lamp provided on the main body 22 in a blinking state.

Then, at a step S206 of the flowchart shown in FIG. 7, a color-difference determination circuit 414 transforms each of the three stimulus values of the desired color and the three stimulus values measured by the first color measurement section 120 into L*a*b before computing a color difference between the two values obtained as a result of the transformation. Subsequently, the flow of the calibration-mode execution represented by the flowchart shown in FIG. 7 goes on to a step S207 to produce a result of determination as to whether or not the color difference is equal to or smaller than a threshold value determined in advance. In this case, the threshold value may be determined in advance on the basis of the allowable color difference cited before. By the way, the allowable color difference cited before may be determined in accordance with a desire of the user who expresses the desire by operating the input section 140. It is needless to say that, as an alternative, in accordance with a certain reference, the allowable color difference cited before may be set at a default value considered to be a value which may be probably desirable when viewed from an objective standpoint. That is to say, the allowable color difference may be set at an already determined value which is not affected by the desire of the user.

It is to be noted that the XYZ table color system does not exhibit a uniform color difference characteristic so that the XYZ table color system is not appropriate for the determination of the color difference. For this reason, in accordance with this embodiment, the color-difference determination circuit 414 transforms each of the three stimulus values of the desired color and the three stimulus values measured by the first color measurement section 120 into L*a*b exhibiting a uniform color difference characteristic before computing a color difference between the two values obtained as a result of the transformation prior to the production of a result of determination as to whether or not the color difference is equal to or smaller than the threshold value determined in advance. In addition, as a white color used in the process to transform each of the three stimulus values of the desired color and the three stimulus values measured by the first color measurement section 120 into L*a*b exhibiting a uniform color difference characteristic, it is recommended to make use of the three stimulus values of the colors of a light source utilized in the measurement of the desired color.

If the determination result produced at the step S207 of the flowchart shown in FIG. 7 is YES meaning an affirmation, the processing circuit 40 terminates the execution of the calibration mode. This is because the affirmation means that one of optimum solutions of the four color components used to display the desired color is the four color components which are used at the present time.

If the determination result produced at the step S207 of the flowchart shown in FIG. 7 is NO meaning a negation, on the other hand, the flow of the calibration-mode execution goes on to a step S208 at which the input-color computaion circuit 410 shifts the original three stimulus values to a certain degree in accordance with a reference determined in advance in order to reduce the color difference. Then, the flow of the calibration-mode execution goes on from the step S208 to the step S203 in order to again compute four color components by making use of the shifted three stimulus values. Thereafter, the processes of the steps S203 to S208 of the flowchart shown in FIG. 7 are carried out repeatedly as long as the color difference between the desired color and the result of the color measurement is neither equal to nor smaller than the threshold value determined in advance.

In this way, the image display apparatus 10 according to the embodiment is made capable of always displaying an accurate color to the user without being affected by an aging degradation of the display panel 100.

Algorithm for Transforming Three Stimulus Values into Four Color Components

In connection with the calibration mode described above, the following description explains an algorithm used for transforming the three stimulus values into the four color components or an equivalent algorithm. To put it more concretely, the algorithm explained below is an algorithm used for transforming the three stimulus values (X, Y, Z) in the XYX table color system into the four color components (R, YG, B, EG).

In the display panel 100 configured to include pixels each having four sub-pixels for the four color components R, YG, B and EG respectively as is the case with the embodiment, the three stimulus values (X, Y, Z) are expressed in terms of the four color components (R, YG, B, EG) by making use of a matrix M_{3×4}, which is a matrix having three rows and four columns, as expressed by Eq. (1) given below.

$$( \begin{matrix}X \\ Y \\ Z\end{matrix} ) = {M}_{3 \times 4} ( \begin{matrix}R \\ YG \\ B \\ EG\end{matrix} ) \qquad ( 1 )$$

Reference notation M_{3×4} used in the above equation denotes a matrix expressed as follows:

$${M}_{3 \times 4} = ( \begin{matrix}{X}_{R} & {X}_{YG} & {X}_{B} & {X}_{EB} \\ {Y}_{R} & {Y}_{YG} & {Y}_{B} & {Y}_{EG} \\ {Z}_{R} & {Z}_{YG} & {Z}_{B} & {Z}_{EG}\end{matrix} )$$

Each matrix element of the above matrix M_{3×4} is a measurement result produced by the first color measurement section 120 for primary colors R, YG, B and EG which are displayed on the display panel 100. In this case, an operation to display a primary color means an operation carried out to produce a display of an attention drawing specific color component corresponding to the primary color on the display panel 100 by making use of an image signal which maximizes the attention drawing specific color component and minimizes color components other than the attention drawing specific color component. For example, the operation to display an R primary color means an operation carried out to produce a display of the R color component corresponding to the R primary color on the display panel 100 by making use of an image signal which maximizes the R color component and minimizes the YG, B and EG color components. The technical term ‘an operation to display a primary color’ is used in the following description also to imply the same operation as what is described above.

It is to be noted that, after all, as is obvious from the above description, elements of the matrix M_{3×4} are explained in detail as follows. The three stimulus values (X_{R}, Y_{R} and Z_{R}) mean a measurement result obtained at a time at which the R primary color is displayed. The three stimulus values (X_{YG}, Y_{YG} and Z_{YG}) mean a measurement result obtained at a time at which the YG primary color is displayed. The three stimulus values (X_{B}, Y_{B} and Z_{B}) mean a measurement result obtained at a time at which the B primary color is displayed. The three stimulus values (X_{EG}, Y_{EG} and Z_{EG}) mean a measurement result obtained at a time at which the EG primary color is displayed.

Since the matrix M_{3×4} used in Eq. (1) is not a regular matrix, the matrix M_{3×4} does not have an inverse matrix. Thus, in order to find the four color components (R, YG, B, EG) from the three stimulus values (X, Y, Z), it is necessary to find a four-row/three-column matrix N_{4×3} satisfying Eq. (2) which is given below as an equation obtained by changing Eq. (1).

$$( \begin{matrix}R \\ YG \\ B \\ EG\end{matrix} ) = {N}_{4 \times 3} ( \begin{matrix}X \\ Y \\ Z\end{matrix} ) \qquad ( 2 )$$

Since the number of elements in the three stimulus values (X, Y, Z) on the right-hand side of Eq. (2) is three while the number of elements in the color components (R, YG, B, EG) on the left-hand side of Eq. (2) is four, it is necessary to reduce the number of elements from four to three by adoption of a proper procedure in finding the four-row/three-column matrix N_{4×3}. By considering the necessity to reduce the number of elements, the four-row/three-column matrix N_{4×3} is found as follows.

(i): The four color components (R, YG, B, EG) are sequentially displayed on the display panel 100 whereas the primary colors expressed for the four color components (R, YG, B, EG) respectively are measured by the first color measurement section 120. The first color measurement section 120 provides the three stimulus values (X_{R}, Y_{R}, Z_{R}) for the R color component which is shown as a displayed color. Thereafter, by the same token, the first color measurement section 120 provides the three stimulus values (X_{YG}, Y_{YG}, Z_{YG}) for the YG color component which is shown as a displayed color. In the same way, the first color measurement section 120 provides the three stimulus values (X_{B}, Y_{B}, Z_{B}) for the B color component which is shown as a displayed color. Likewise, the first color measurement section 120 provides the three stimulus values (X_{EG}, Y_{EG}, Z_{EG}) for the EG color component which is shown as a displayed color.

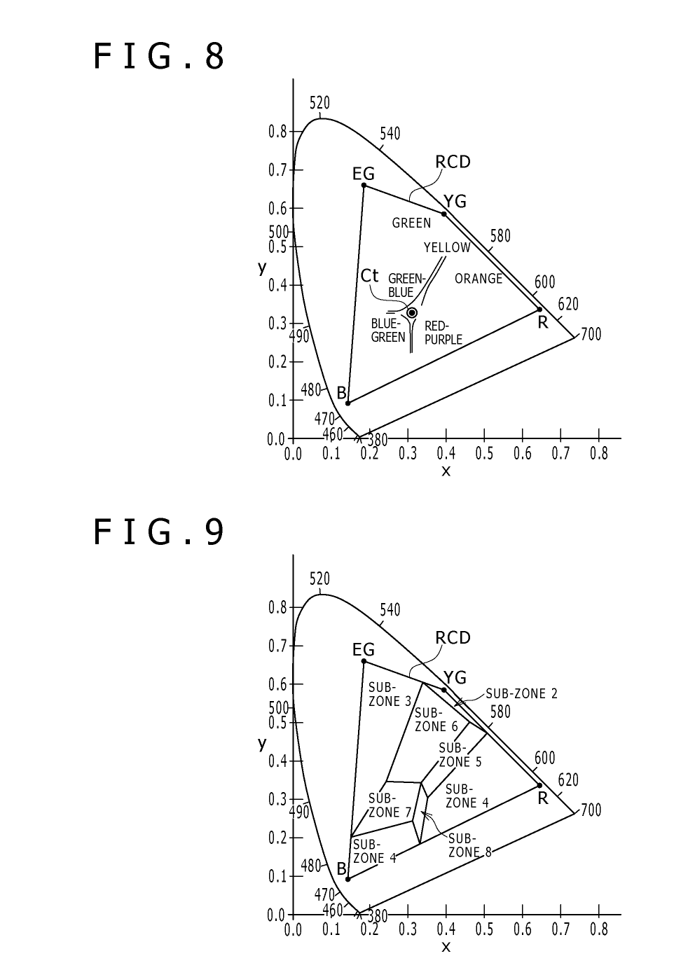

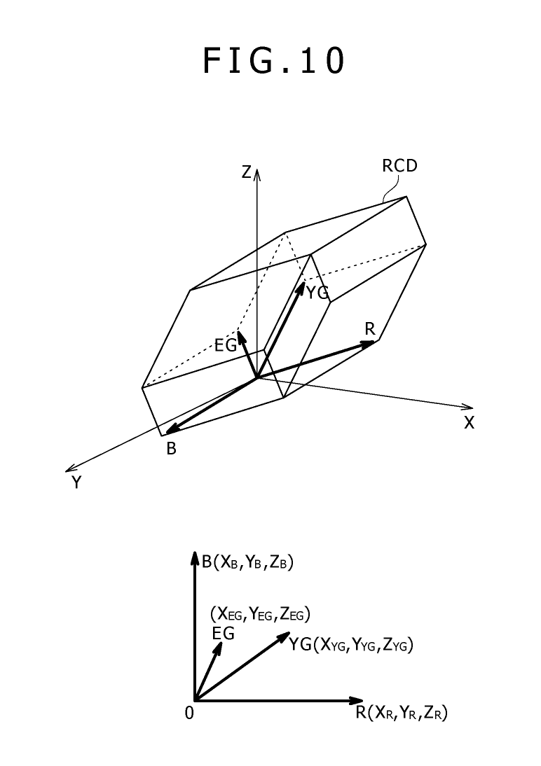

From process (i) described above, a zone RCD of color reproduction by the display panel 100 according to the embodiment is found. This color reproduction zone RCD can be expressed on a chromaticity diagram like an xy chromaticity diagram of FIG. 8. It is to be noted that reference symbol Ct shown in the xy chromaticity diagram of FIG. 8 denotes a white point. As an alternative, the color reproduction zone RCD can be expressed as a three-dimensional solid RCD in an XYZ space as shown in an upper diagram of FIG. 10. As shown in the upper diagram of FIG. 10, the three axes of the XYZ space represent the three stimulus values X, Y and Z respectively. In general, a color reproduction zone for a case in which P colors are used is expressed by a solid which has P(P−1) surfaces. Thus, since the display panel 100 according to the embodiment makes use of four colors, the color reproduction solid RCD of the display panel 100 according to the embodiment is expressed by a solid which has 12 (=4(4−1)) surfaces as shown in the upper diagram of FIG. 10. It is to be noted that a set of vectors R, YG, B and EG shown in the upper diagram of FIG. 10 is the same set of vectors as that shown in a lower diagram of FIG. 10 with the only exception that the directions of the vectors R, YG, B and EG shown in the upper diagram of FIG. 10 are different from the directions of the corresponding vectors shown in the lower diagram of FIG. 10.

(ii): The color reproduction zone RCD found in process (i) is divided into sub-zones.

Conditions for the division are EG=0, B=0, R=0, YG=0, R=YG, YG=EG, B=EG and R=B. When these conditions of the division are satisfied, one of the four elements can be ignored, so to speak. Thus, the number of elements is reduced from four to three.

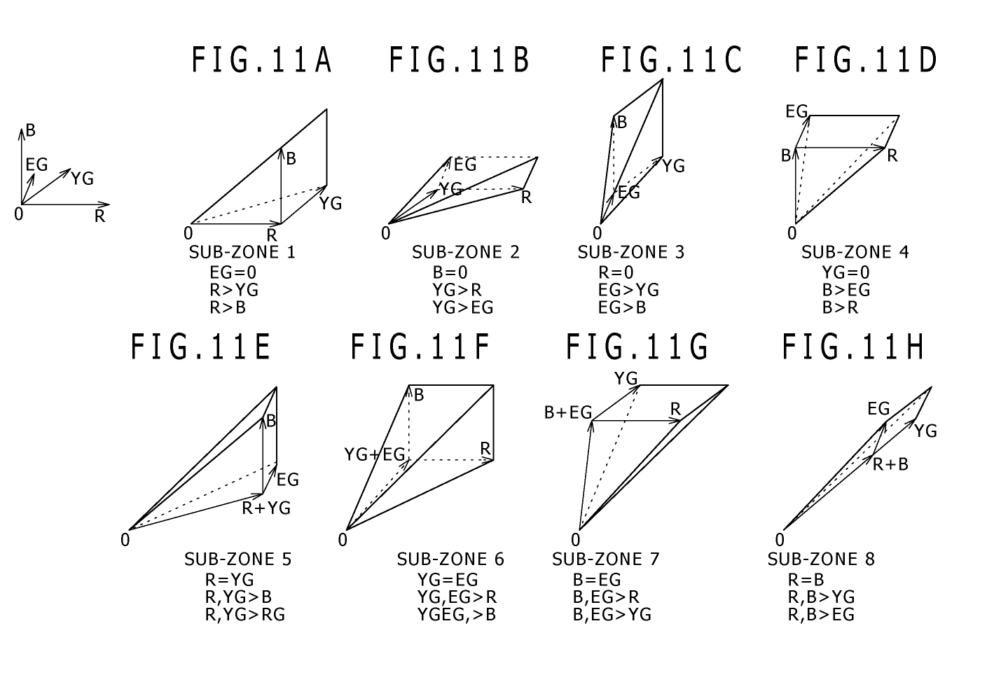

Let the 12-surface solid shown in the diagram of FIG. 10 referred to earlier be set forth as a premise for example. In this case, the division like the one cited above means that the solid having 12 surfaces is divided into eight four-sided cones. Sub-solids each obtained as a result of the division are shown in diagrams of FIGS. 11A to 11H. In the case of the four-side cone shown in the diagram of FIG. 11A for example, only the vector EG is 0 while relations R>YG and R>B hold true. The division can also be expressed on a chromaticity diagram. In this case, sub-zones each obtained as a result of the division are shown in a diagram of FIG. 9. FIG. 9 is provided as a diagram to be referred to in comparison with the diagram of FIG. 8.

(iii): For every sub-zone having an element count reduced in process (ii), the matrix N_{4×3} is found. Details of process (iii) are explained as follows.

First of all, let reference notation (Rₙ, YGₙ, Bₙ, EGₙ)^{t} denote a vector representing scalar values R, YG, B and EG whereas reference notation (Xₙ, Yₙ, Zₙ)^{t} denote a vector representing the three stimulus values X, Y and Z. In (Rₙ, YGₙ, Bₙ, EGₙ)^{t} and (Xₙ, Yₙ, Zₙ)^{t}, n has a value of 1, 2, 3 or 4, that is, n=1, 2, 3 or 4, whereas symbol t attached to the parenthesis “ ” of each of the vector (Rₙ, YGₙ, Bₙ, EGₙ)^{t} and the vector (Xₙ, Yₙ, Zₙ)^{t} stands for the technical term ‘transport’. In this case, Eq. (1) can be rewritten into Eq. (3) as follows:

$$( \begin{matrix}{X}_{1} & {X}_{2} & {X}_{3} & {X}_{4} \\ {Y}_{1} & {Y}_{2} & {Y}_{3} & {Y}_{4} \\ {Z}_{1} & {Z}_{2} & {Z}_{3} & {Z}_{4}\end{matrix} ) = {M}_{3 \times 4} ( \begin{matrix}{R}_{1} & {R}_{2} & {R}_{3} & {R}_{4} \\ {YG}_{1} & {YG}_{2} & {YG}_{3} & {YG}_{4} \\ {B}_{1} & {B}_{2} & {B}_{3} & {B}_{4} \\ {EG}_{1} & {EG}_{2} & {EG}_{3} & {EG}_{4}\end{matrix} ) \qquad ( 3 )$$

Let reference notation M_{xyz} denote the matrix on the left-hand side of Eq. (3) whereas reference notation M_{R-YG-B-EG} denote the matrix included in the expression provided on the right-hand side of Eq. (3) as an expression which also includes the matrix M_{3×4}. In this case, Eq. (3) can be rewritten into M_{xyz}=M_{3×4}×M_{R-YG-B-EG}. Thus, Eq. (2) given earlier can be expressed as Eq. (4) given as follows.

M_{R-YG-EG}=N_{4×3}·M_{XYZ} (4)

Then, each of the terms on both sides of Eq. (4) is multiplied by M_{xyz}^{t} to result in Eq. (5) which is given as follows.

M_{R-YG-B-EG}·M_{XYZ}^{t}=N_{4×3}·M_{XYZ}·M_{XYZ}^{t} (5)

Since M_{xyz}×M_{xyz}^{t} on the right-hand side of Eq. (5) is a three-row/three-column regular matrix, an inverse matrix (M_{xyz}×M_{xyz}^{t})⁻¹ thereof exists. Then, each of the expressions on both sides of Eq. (5) is multiplied by the inverse matrix (M_{xyz}×M_{xyz}^{t})⁻¹ in order to yield an intermediate equation from which Eq. (6) is derived as an equation expressing a matrix N_{4×3} as follows.

N_{4×3}=(M_{R-YG-B-EG}·M_{XYZ}^{t})(M_{XYZ}·M_{XYZ}^{t})⁻¹ (6)

Eq. (6) is used to find a matrix N_{4×3} for each of sub-zones 1 to 8 described before.

At the step S203 of the flowchart described before by referring to FIG. 7, the matrix N_{4×3} found as described above is used.

Surrounding-Environment-Light-Based Adjustment Mode

The surrounding-environment-light-based adjustment mode is a mode in which a color expressed on the display panel 100 is modified in accordance with the color of light coming from an environment surrounding the image display apparatus 10 which employs the display panel 100. As is commonly known, in general, even when a physical body is objectively perceived, the same body may be perceived and/or recognized at colors different from the true colors of the body in some cases due to changes in attributes such as the color and property of light coming from the environment which surrounds the body. When a white cloth is perceived at any time of the day and at night for example, the cloth coloring for the time of the day of full daylight coming from the sun seemingly tends to be typically different from the cloth coloring for incandescent light at the nighttime.

In the image display apparatus 10 according to the embodiment, the image display apparatus 10 shows a color proper for such changing light coming from the environment surrounding the image display apparatus 10. In this case, an operation to display a proper color implies an operation to display a color which matches reality to a higher degree. That is to say, the operation to display a proper color means an operation to express a color which should be naturally visible to the user and display the color every time the light coming from the environment surrounding the image display apparatus 10 changes. In other words, the operation to display a proper color does not imply an operation to display a color which remains unchanged even though the light coming from the environment surrounding the image display apparatus 10 changes. It is to be noted that, as already explained before, the word ‘adjustment’ used in this specification of the application and the range of every claim appended to the specification is to be interpreted as a word that has the meaning described above in the background thereof.

Details of the adjustment are described as follows.

Basically, the embodiment follows Bladford's color adjustment prediction technique which is described as follows.

[I]: The three stimulus values (Xₛ, Yₛ, Zₛ) of the original color are transformed into response characteristics (Rₛ, Gₛ, Bₛ) of a cone.

[II]: The response characteristics of a cone of the original color are cancelled and transformation into response characteristics (Rₑ, Gₑ, Bₑ) of a cone resulted in by light coming from the surrounding environment is carried out.

[III]: The response characteristics (Rₑ, Gₑ, Bₑ) of the cone resulted in by light coming from the surrounding environment are transformed into three stimulus values (Xₑ, Yₑ, Zₑ).

Here, let the three stimulus values of the original color be represented by a vector (Xₛ, Yₛ, Zₛ)^{t} and, in addition, let the three stimulus values for the response characteristics described above as the response characteristics of the cone resulted in by light coming from the surrounding environment be represented by a vector (Xₑ, Yₑ, Zₑ)^{t}. In this case, computations (I) to (III) described above can be expressed by Eq. (7) including a matrix T given as follows:

$$( \begin{matrix}{X}_{e} \\ {Y}_{e} \\ {Z}_{e}\end{matrix} ) = T ( \begin{matrix}{X}_{s} \\ {Y}_{s} \\ {Z}_{s}\end{matrix} ) \qquad ( 7 )$$

In the following description, the matrix T is also referred to as a surrounding-environment-light-based adjustment transformation matrix in some cases.

Thus, if the vector (Xₛ, Yₛ, Zₛ)^{t} included in the expression on the right-hand side of Eq. (7) is regarded to be the same as typically three stimulus values eventually found in the processing represented by the flowchart shown in FIG. 7 as the processing carried out in the calibration mode, three stimulus values representing a specific color are found. The specific color is a color which is probably recognized or perceived for a case in which the color for the three stimulus values eventually found in the processing is placed under predetermined light coming from the surrounding environment. The three stimulus values representing the specific color are the three stimulus values (Xₑ, Yₑ, Zₑ) on the left-hand side of Eq. (7). Then, a color is shown on the display panel 100 by making use of the three stimulus values (Xₑ, Yₑ, Zₑ).

Let reference notation T_{BFD} denote a matrix used for transforming three stimulus values into response characteristics of a cone in computation [I] described above and let reference notation T_{A} denote a matrix used for cancellation of the response characteristics of a cone for the original color and for transformation into response characteristics of a cone resulted in by light coming from the surrounding environment in computation [II] described above. In this case, a surrounding-environment-light-based adjustment matrix T included in the expression on the right-hand side of Eq. (7) can be found in accordance with Eq. (8) which is given as follows.

T=(T_{BFD})⁻¹(T_{A})(T_{BFD}) (8)

The matrix T_{BFD} included in the expression on the right-hand side of Eq. (8) is expressed in terms of concrete numbers in accordance with Eq. (9) given as follows.

$${T}_{BFD} = ( \begin{matrix}0.8951 & 0.2664 & - 0.1614 \\ - 0.7502 & 1.7135 & 0.0367 \\ 0.0389 & - 0.0685 & 1.0296\end{matrix} ) \qquad ( 9 )$$

The matrix T_{A} included in Eq. (8) is found as follows.

Let a vector (X_{ws}, Y_{ws}, Z_{ws})^{t} represent the three stimulus values of the original light-source color whereas a vector (R_{ws}, G_{ws}, B_{ws})^{t} represent response characteristics of a cone based on the three stimulus values. In addition, let a vector (X_{we}, Y_{we}, Z_{we})^{t} represent the three stimulus values of a color of light coming from the surrounding environment whereas a vector (R_{we}, G_{we}, B_{we})^{t} represent response characteristics of a cone based on the three stimulus values of the color of light coming from the surrounding environment. In this case, the vector (X_{ws}, Y_{ws}, Z_{ws})^{t} is related to the vector (R_{ws}, G_{ws}, B_{ws})^{t} in accordance with Eq. (10) making use of the matrix T_{BFD} as shown below whereas the vector (X_{we}, Y_{we}, Z_{we})^{t} is related to the vector (R_{we}, G_{we}, B_{we})^{t} in accordance with Eq. (11) making use of the matrix T_{BFD} as shown below.

$$\begin{matrix}( \begin{matrix}{R}_{ws} \\ {G}_{ws} \\ {B}_{ws}\end{matrix} ) = {T}_{BFD} ( \begin{matrix}{X}_{ws} \\ {Y}_{ws} \\ {Z}_{ws}\end{matrix} ) & ( 10 ) \\ ( \begin{matrix}{R}_{we} \\ {G}_{we} \\ {B}_{we}\end{matrix} ) = {T}_{BFD} ( \begin{matrix}{X}_{we} \\ {Y}_{we} \\ {Z}_{we}\end{matrix} ) & ( 11 )\end{matrix}$$

From Eqs. (10) and (11), the matrix T_{A} included in Eq. (8) is found in accordance with Eq. (12) as follows.

$${T}_{A} = ( \begin{matrix}\frac{{R}_{we}}{{R}_{ws}} & 0 & 0 \\ 0 & \frac{{G}_{we}}{{G}_{ws}} & 0 \\ 0 & 0 & \frac{{B}_{we}}{{B}_{ws}}\end{matrix} ) \qquad ( 12 )$$

As is obvious from Eq. (12), the matrix T_{A} is a regular matrix. Each of the diagonal elements of the regular matrix T_{A} is obtained by dividing an element of the vector (R_{we}, G_{we}, B_{we})^{t} expressed by Eq. (11) by a corresponding element of the vector (R_{ws}, G_{ws}, B_{ws})^{t} expressed by Eq. (10) to serve as a vector. The concrete expression of “the cancellation of response characteristics of a cone of the original color” can be regarded to appear as the divisions in Eq. (12).

Eqs. (9) and (12) described above are substituted into Eq. (8) expressing the surrounding-environment-light-based adjustment matrix T. Then, on the basis of Eq. (7) including the surrounding-environment-light-based adjustment matrix T, the three stimulus values (Xₑ, Yₑ, Zₑ) for the light coming from the surrounding environment are found.

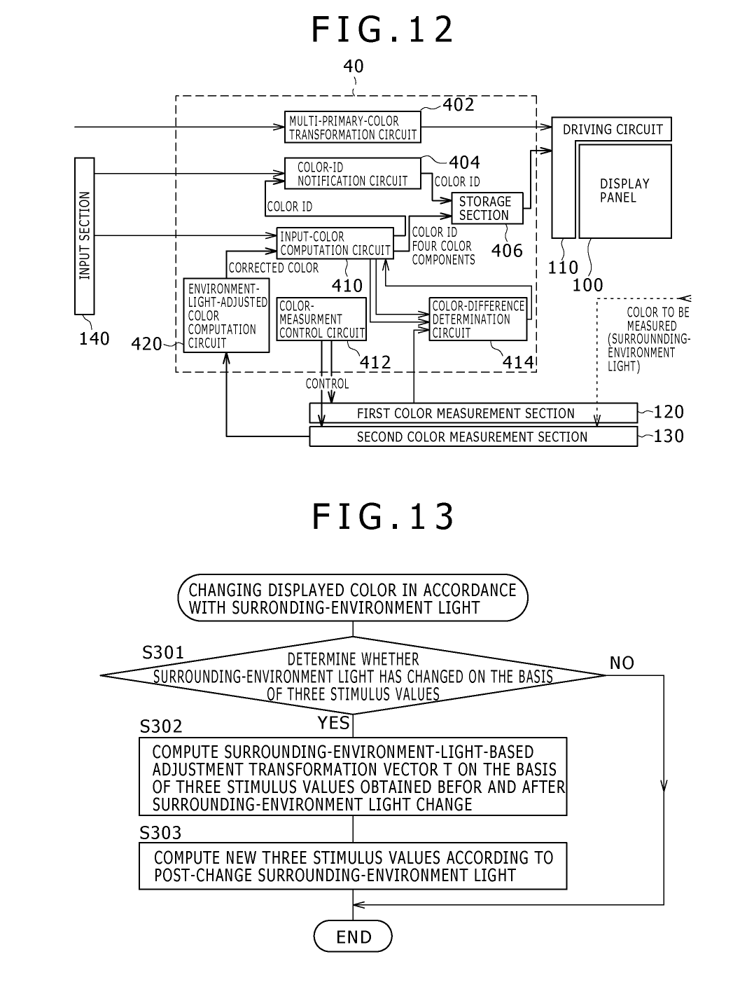

In the following description, on the assumption that the displayed color is changed on the basis of such a principle, the flow of processing to change the displayed color is concretely explained by referring to a block diagram of FIG. 12 and a flowchart shown in FIG. 13. FIG. 12 is a block diagram showing a functional configuration constructed by the processing circuit 40 employed in the image display apparatus 10 set in a surrounding-environment-light-based adjustment mode. On the other hand, FIG. 13 shows a flowchart representing operations carried out in the surrounding-environment-light-based adjustment mode.

First of all, a color-measurement control circuit 412 issues a command to the second color measurement section 130 in order to request the second color measurement section 130 to measure the color of surrounding-environment light which is light coming from the environment surrounding the image display apparatus 10. At a step S301 of the flowchart shown in FIG. 13, on the basis of three stimulus values obtained as a result of the color measurement carried out by the second color measurement section 130, an environment-light adjusted color computaion circuit 420 shown in the block diagram of FIG. 12 produces a result of determination as to whether or not the surrounding-environment light has changed with the lapse of time. To put it more concretely, in the process carried out at this step, the environment-light adjusted color computaion circuit 420 shown in the block diagram of FIG. 12 produces a result of determination as to whether or not the vector included in the expression on the right-hand side of Eq. (10) has changed to the vector included in the expression on the right-hand side of Eq. (11) by at least a difference determined in advance. If the result of the determination indicates that the vector included in the expression on the right-hand side of Eq. (10) has changed to the vector included in the expression on the right-hand side of Eq. (11) by at least a difference determined in advance, the matrix TA included in the expression on the right-hand side of Eq. (8) can be computed by making use of Eqs. (10) to (12).

It is to be noted that the process of producing a result of determination as to whether or not the vector included in the expression on the right-hand side of Eq. (10) has changed to the vector included in the expression on the right-hand side of Eq. (11) by at least a difference determined in advance is well carried out at this step because the process properly takes some points described below into consideration. For example, in the first place, the time interval set to lapse prior to the determination as to whether or not the vector has changed is taken into consideration. The time at which the existence of such a change is determined is the present point of time which naturally does not move in principle. Basically, however, a past point of time for the vector to be compared with another vector observed at the present point of time can be set with a high degree of freedom. Let reference symbol t0 denote the present point of time whereas reference symbol t1 denote the past point of time. In this case, the length of the time interval |t0−t1| set to lapse prior to the determination as to whether or not the vector has changed to the other vector can be set with a high degree of freedom.

In the second place, the difference used as a criterion as to whether or not the vector has changed to the other vector can basically be set in advance with a high degree of freedom. This difference which can basically be set in advance with a high degree of freedom is compared with the difference between the vector (X_{ws}, Y_{ws}, Z_{ws})^{t} used in Eq. (10) and the vector (X_{we}, Y_{we}, Z_{we})^{t} used in Eq. (11). To put it more concretely, for example, if one of the components of the vector (X_{ws}, Y_{ws}, Z_{ws})^{t} is merely different a little bit from the corresponding one of the components of the vector (X_{we}, Y_{we}, Z_{we})^{t}, the existence of a change is confirmed. As an alternative, a norm between the vector (X_{ws}, Y_{ws}, Z_{ws})^{t} and the vector (X_{we}, Y_{we}, Z_{we})^{t} is computed and compared with a threshold value determined in advance in order to determine the existence of such a change. That is to say, if the computed norm is found equal to or greater than the threshold value determined in advance, the existence of such a change is confirmed. In this case, the norm between the vector (X_{ws}, Y_{ws}, Z_{ws})^{t} and the vector (X_{we}, Y_{we}, Z_{we})^{t} is defined as the value of the expression {(X_{we}−X_{ws})²+(Y_{we}−Y_{ws})²+(Z_{we}−Z_{ws})²}^{(1/2)}.

If the determination result produced at the step S301 of the flowchart shown in FIG. 13 is NO indicating that the change does not exist, the processing carried out in the surrounding-environment-light-based adjustment mode is terminated.

If the determination result produced at the step S301 of the flowchart shown in FIG. 7 is YES indicating that the change exists, on the other hand, the flow of the processing carried out in the surrounding-environment-light-based adjustment mode goes on to a step S302 of the flowchart shown in FIG. 13. At this step, the environment-light adjusted color computaion circuit 420 computes the surrounding-environment-light-based adjustment matrix T in accordance with Eq. (8) from the matrix TA and the matrix TBFD expressed by Eq. (9). Then, the processing carried out in the surrounding-environment-light-based adjustment mode goes on to a step S303 of the flowchart shown in FIG. 13. At this step, the environment-light adjusted color computaion circuit 420 computes new three stimulus values according to post-change surrounding-environment light by making use of Eq. (7) from this surrounding-environment-light-based adjustment matrix T and the three stimulus values of a color shown on the display panel 100 at the present time. It is to be noted that the technical term ‘Corrected color’ is used in the block diagram of FIG. 12 and other block diagrams to indicate that the computed new three stimulus values are supplied from the environment-light adjusted color computaion circuit 420 to an input-color computaion circuit 410.

Thereafter, a display operation is carried out on the basis of these computed new three stimulus values. The procedure for carrying out the display operation is typically the procedure which has been explained by referring to the flowchart shown in FIG. 7. It is to be noted that, as explained earlier, the technical term ‘adjusted color components’ used in the description of the present embodiments include the four color components R, YG, B and EG which are computed at the step S203 of the flowchart shown in FIG. 7 on the basis of the three stimulus values newly computed as described above.

It is to be noted that the user may determine whether or not to carry out the processing to change a displayed color in accordance the light coming from the surrounding environment as described above. That is to say, whether or not to carry out such processing may be determined in accordance with the desire of the user. In other words, it is necessary to carry out the processing to change a displayed color in accordance the light coming from the surrounding environment as described above only when the user desires the processing. When the user does not desire the processing to change a displayed color in accordance the light coming from the surrounding environment as described above, on the other hand, the processing is not carried out in particular. The desire of the user can be expressed by operating the input section 140.

In addition, if the color of light coming from the surrounding environment changes from time to time, that is, if the color of light coming from the surrounding environment is ECa at first, then changes to ECb and, later, changes to ECc for example, the existence of the change may be determined at the step S301 of the flowchart shown in FIG. 13 by considering a state immediately leading ahead of the present time as a reference. That is to say, in the case of the typical colors ECa, ECb and ECc given above, for a state transition from the color ECa to the color ECb, the color ECb is compared with the color ECa in order to determine whether or not a change exists. By the same token, for a state transition from the color ECb to the color ECc, the color ECc is compared with the color ECb in order to determine whether or not a change exists.

In addition, the surrounding-environment-light-based adjustment mode described above is preferably used as follows.

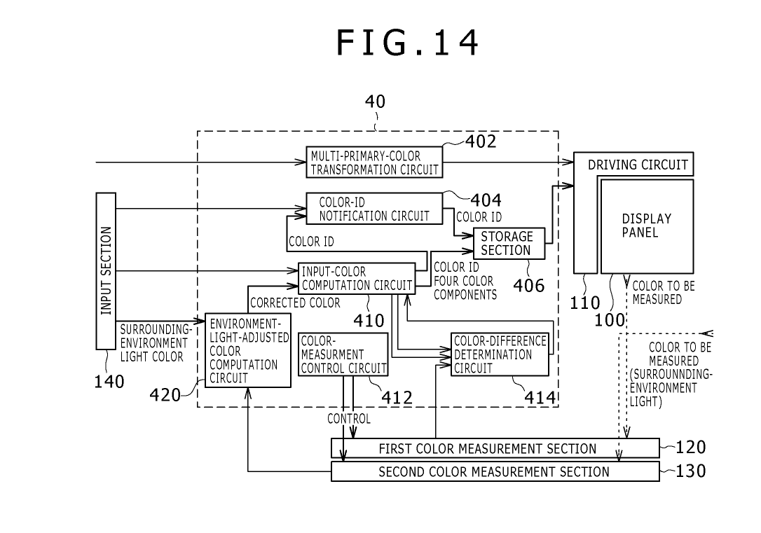

As described above, when the color of light coming from the surrounding environment changes at the present point, the color shown on the display panel 100 is updated in accordance with the change of the color of light coming from the surrounding environment. That is to say, the surrounding-environment-light-based adjustment mode is mainly used on the assumption that the color shown on the display panel 100 is updated in a passive manner. In a manner opposite to the passive manner, so to speak, it is also possible to provide a configuration in which the color shown on the display panel 100 is updated in an active manner. For example, as shown in a diagram of FIG. 14, the environment-light adjusted color computaion circuit 420 receives a color of light coming from the surrounding environment as a color to be referred to not from the second color measurement section 130, but from the input section 140. In this case, the color exhibited by the light coming from the surrounding environment as a color to be referred to is determined with a high degree of freedom in accordance with the desire of the user. In accordance with this configuration, the color of the light coming from the surrounding environment may not actually change. However, it is possible to recognize a color to which the color shown on the display panel 100 will change should the color of the light coming from the surrounding environment actually change at the present time. That is to say, by virtue of this configuration, it is possible to have the so-called soft proof for virtually verifying the actual appearance that would be seen on the display panel 100.

In the case of the typical example described above, the surrounding-environment light color itself is directly specified by the user. It is to be noted, however, that in place of the function to allow the user to directly specify the color of light coming from the surrounding environment or in addition to this function, the embodiment has the processing circuit 40 provided with a second storage section which is used for storing a plurality of surrounding-environment light colors in advance as a set of colors. The user is allowed to select a color from the set of colors and capable of verifying a color which will actually appear on the display panel 100 should the color of the light coming from the surrounding environment change to the selected color. It is thus needless to say that this embodiment provides more convenience than convenience offered by a configuration in which the user directly enters three stimulus values to the image display apparatus 10.

As described above, in accordance with the image display apparatus 10 according to an embodiment has an effect that, when the color and property of the color of light from the surrounding environment change from the color and the property which have been exhibited so far, a proper color can be displayed to the user as a color which is created in accordance with the color and property changes. This effect is obtained mainly as a result of execution of operations in the surrounding-environment-light-based adjustment mode.

An embodiment has been described so far. However, the image display apparatus 10 according to the present application is by no means limited to the embodiment. That is to say, a variety of modified versions described below can be used to implement the image display apparatus 10.

(1): First Modified Version

In the surrounding-environment-light-based adjustment mode of the embodiment, if light coming from the surrounding environment changes, new three stimulus values are found immediately to replace three stimulus values used at the present point of time. However, implementations of the present application are by no means limited to this feature of the embodiment.

For example, in place of the surrounding-environment-light-based adjustment matrix T included in Eq. (7), it is possible to make use of a matrix T′ which is expressed by Eq. (13) as follows:

$${T}^{′} = x T + ( 1 - x ) ( \begin{matrix}1 & 0 & 0 \\ 0 & 1 & 0 \\ 0 & 0 & 1\end{matrix} ) \qquad ( 13 )$$

In the above equation, reference notation x denotes a variable changing in the range 0 to 1 at a rate determined in advance within a fixed lapse of time. Reference notation T denotes basically the same matrix as the surrounding-environment-light-based adjustment matrix T described before. The matrix T is computed in the process carried out at the step S302 of the flowchart shown in FIG. 13 when the existence of a change is confirmed in the determination process carried out at the step S301 of the same flowchart.

In this first modified version, a process described below is carried out as a process corresponding to the process performed at the step S303 of the flowchart shown in FIG. 13. After the light coming from the surrounding environment changes, new three stimulus values are not found and used immediately. Instead, new three stimulus values to be used are found from time to time in accordance with Eq. (13) and the rate at which the value of the variable x is changing. Then, in this first modified version, four color components based on their respective new three stimulus values found from time to time are computed from time to time for their respective new three stimulus values by adoption of the same computation method as that adopted in the process carried out at the step S203 of the flowchart shown in FIG. 7. As a result, the color shown in the display panel 100 is changed at a slow rate, so to speak, in comparison with the changes of the light coming from the surrounding environment.

Thus, in accordance with this first modified version, it is possible to preventively get rid of a problem that the user feels flickering due to abrupt changes of the displayed color.

It is to be noted that, in this first modified version, while the variable x is changing, it is desirable to stop the color measurement function of the second color measurement section 130 or to ignore a measured color which is obtained as a result of measurement in case the color measurement function of the second color measurement section 130 is continued. This is because, if the displayed color is further changed when a new change of the light coming from the surrounding environment is detected in the course of an operation to change the displayed color at a slow rate, it is feared that the process becomes confusing.

(2): Second Modified Version

In the case of the embodiment described above, the first color measurement section 120 or the second color measurement section 130 is provided to serve as a part of the image display apparatus 10. However, implementations of the present application are by no means limited to the embodiment. For example, it is possible to provide a modified version in which color measurement sections having the functions of the first color measurement section 120 and the second color measurement section 130 are employed to serve as sections physically separated from the image display apparatus. In the case of such a modified version, only one color measurement section will be sufficient. This second modified version is provided because of the following reason. Since the color measurement sections are employed to serve as sections physically separated from the image display apparatus, it is no longer feared that the image display apparatus must be designed under a special restriction demanding that the measurement surface of each of the color measurement section be oriented in a direction toward the display panel 100 or the environment surrounding the image display apparatus. To be more specific, there is no condition demanding that the measurement surface of a color measurement section having a function of the first color measurement section 120 employed in the embodiment be oriented in a direction toward the display panel 100 and the measurement surface of a color measurement section having a function of the second color measurement section 130 employed in the embodiment be oriented in a direction toward the environment surrounding the image display apparatus.

(3): Third Modified Version

In the case of the embodiment described above, the display panel 100 is a liquid-crystal panel. However, implementations of the present application are by no means limited to the embodiment. For example, the display panel according to the present application can also be an organic EL device or the like.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. An image display apparatus comprising:
a display panel in which every pixel is configured to have at least four sub-pixels provided for respectively at least four color components different from each other and each of said sub-pixels is driven to exhibit a luminance according to said color component for said sub-pixel;
a processing circuit configured to receive input information provided for said display panel to serve as information on a color prescribed by a table color system determined in advance and configured to output said four or more color components based on said information; and
a color measurement unit configured to measure the color of light coming from an environment surrounding said display panel,
wherein, if a color measured by said color measurement unit as the color of light coming from said environment at a first point of time is different from a color measured by said color measurement unit as the color of light coming from said environment at a second point of time following said first point of time, said processing circuit outputs at least four such adjusted color components that a color prescribed by said information is adjusted to said color of said light coming from said environment at said second point of time.

2. The image display apparatus according to claim 1 wherein said processing circuit outputs said four or more adjusted color components by changing said four or more adjusted color components from time to time so that a color shown on said display panel at said first point of time changes gradationally to a color which is based on said four or more adjusted color components.

3. The image display apparatus according to claim 1 wherein said color of light coming from said environment surrounding said display panel at said second point of time is not a color measured by said color measurement section, but a color determined in accordance with a command which is issued by the user.

4. A driving method for driving an image display apparatus having a display panel in which every pixel is configured to have at least four sub-pixels provided for respectively at least four color components different from each other and each of said sub-pixels is driven to exhibit a luminance according to said color component for said sub-pixel, said driving method comprising the steps of:
receiving input information provided for said display panel to serve as information on a color prescribed by a table color system determined in advance and outputting said four or more color components based on said information; and
measuring the color of light coming from an environment surrounding said display panel,
whereby, if a color measured at said color measurement process as said color of light coming from said environment at a first point of time is different from a color measured at said color measurement process as said color of light coming from said environment at a second point of time following said first point of time, said color-component outputting process is carried out to output at least four such adjusted color components that a color prescribed by said information is adjusted to said color of light coming from said environment at said second point of time.

5. An image display program to be executed by a computer for driving an image display apparatus having a display panel in which every pixel is configured to have at least four sub-pixels provided for respectively at least four color components different from each other and each of said sub-pixels is driven to exhibit a luminance according to said color component for said sub-pixel wherein:
said computer executes said image display program in order to function as a processing section configured to receive input information provided for said display panel to serve as information on a color prescribed by a table color system determined in advance and to output said four or more color components based on said information as well as to serve a color measurement section configured to measure the color of light coming from an environment surrounding said display panel; and
said processing section also serves as a color-component outputting section configured to further output at least four such adjusted color components that a color prescribed by said information is adjusted to the color of light coming from said environment at a second point of time following a first point of time if a color measured by said color measurement section as the color of light coming from said environment at said first point of time is different from a color measured by said color measurement section as the color of light coming from said environment at said second point of time.
